(19) United States
(12) Patent Application Publication
(10) Pub. No.: US 2006/0168198 A1
(43) Pub. Date: Jul. 27, 2006

(54) Web page browsing timer and method thereof

(75) Inventors: Iris Yang, Beijing (CN); Pinky Ma, Beijing (CN); Zechary Chang, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/043,828

(22) Filed: Jan. 26, 2005

(51) Int. Cl. G06F 15/173

(52) U.S. Cl. 709/224

(57) ABSTRACT

A web page browsing timing system and method thereof are disclosed for timing the web page browsing time of the user. When user login information is received, the server starts a first timing system according to the login information. Then, an inline floating frame updates regularly the first timing system on the server, and starts a second timing system contained in the inline floating frame, which is set with a predetermined time. The system compares the current time with the time of the second timing system. If the current time reaches the predetermined time, the system calls the server to update the first timing system.

### BACKGROUND

1. Field of the Invention

The invention relates to a timing system and method and, in particular, to a web page browsing timing system and method thereof.

2. Description of the Related Art

As the network becomes popular, more users start to enjoy the abundant contents brought by the high-speed network. Users can make good use of the bandwidth for long-time data transmissions. However, problems and disputes also surface. One of the serious problems is the computation of connection time and fare.

There are two ways to charge by time for browsing a website: downloading a user engine of timing and forcing login and logout of a web page. The drawback of downloading a user engine of timing is that the user has to download a user engine. This takes a longer time and renders a change for virus infection. The method of forcing login and logout of a web page may result in user's loss when the user forgets to log out or the machine is out of order so that the system cannot recognize and continues to charge.

For most users, the ratio of the network speed and charge is always a primary index that they evaluate and select network service carriers. The fee is usually charged by time. Therefore, how to make the computation of network time in a more reasonable way to increase user satisfaction is a key issue for commercial websites.

### SUMMARY OF THE INVENTION

In view of the foregoing, the invention provides a web page browsing timing system and method thereof. An objective of the invention is to provide a mechanism to accurately compute the network using time of a current user, making the web page browsing charge more reasonable.

To achieve the above objective, the invention provides a web page browsing timing system, which uses a first timing system on the server to time while a user browses a web page. It is characterized in including an inline floating frame (Iframe) in the web page. The inline floating frame is connected to the first timing system on the web page server. The inline floating frame includes a second timing system that is called the server to update the first timing system according to a predetermined time.

Moreover, the invention provides a timing method for web page browsing. The web page contains an inline floating frame, which updates the first timing system on the server regularly according to a predetermined time. First, start the first timing system on the server once user login information is received. Update regularly the first timing system on the server via the inline floating frame, of which the step comprises starting a second timing system by the inline floating frame, comparing its time with the current time to acquire a comparison result, and calling the server via the inline floating frame to update the first timing system according to the comparison result.

According to the disclosed timing system and the corresponding timing method, the first timing system on the server is called for timing and is updated regularly. When a user quits the web page in an anomalous way, the first timing system on the server stops timing. The timing information on the server stops changing once the user quits the web page. When the user logs in again, the first timing system continues timing, so that the web page browsing time is calculated more accurate and reasonable.

### BRIEF DESCRIPTION OF THE DRAWINGS

The invention will become more fully understood from the detailed description given hereinbelow illustration only, and thus are not limitative of the present invention, and wherein:

FIG. 1 shows the module structure of a web page browsing timing system according to an embodiment of the invention;

FIG. 2 is a flowchart showing the operation of a web page browsing timing method according to an embodiment of the invention;

FIG. 3 is a flowchart showing the operation of a web page browsing timing method according to an embodiment of the invention when the user quits in an anomalous way or logs out the browsing web page; and

FIG. 4 is a flowchart showing an embodiment of the operation of a web page browsing timing method according to the invention.

### DESCRIPTION OF THE INVENTION

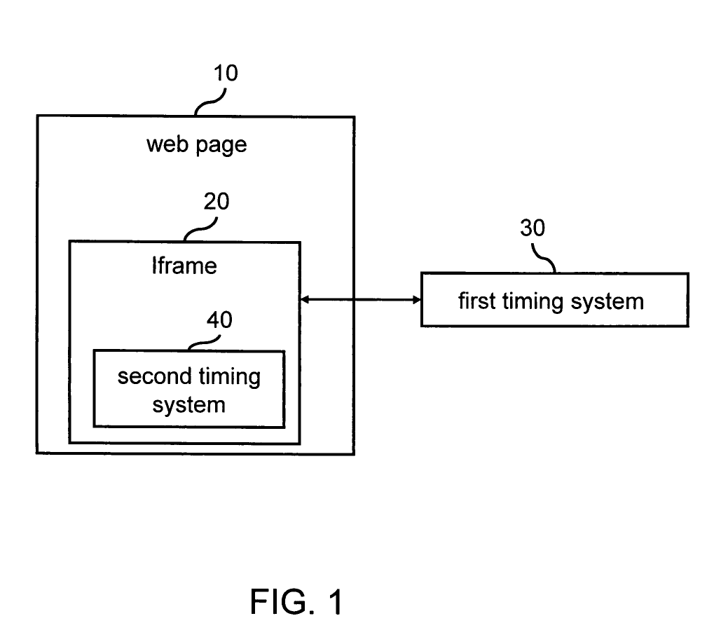

The invention relates to a web page browsing timing system and method thereof. Referring to FIG. 1, we explain the operation of the web page browsing timing system according to an embodiment of the invention.

The server contains a first timing system 30 for timing a web page browser. And an inline floating frame (Iframe) 20 is added to a web page 10, and the Iframe 20 can be embedded at any place of the web page. At the level of script language and objects, the window containing the Iframe 20 is usually called a parent list and the Iframe 20 is called a daughter list. Visiting from the parent list to the daughter list requires a clear definition of object levels so that one may visit and control the lists using a program. Although, Iframe 20 is embedded in another HTML document, it maintains its relative independence. The disclosed Iframe 20 contains a second timing system 40, which runs a timing program with a predetermined time. When the predetermined time is reached, the web page 10 calls the server to update the first timing system 30 and determines the user's privilege. At this moment, the parent page is not updated, without affecting the user in browsing the web page contents. When the user anomalously quits or logs out the browsing web page, the inline floating frame 20 does not call the server regularly to update the first timing system 30. Thus, the first timing system 30 on the server stops timing and keeps the timing data. When the user logs in again, the system determines the user's privilege and starts the first timing system 30 on timing again.

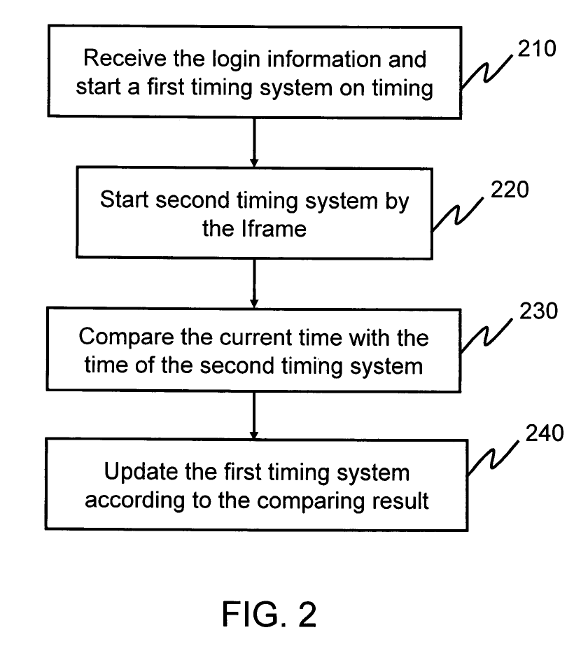

Referring to FIG. 2, we explain the procedure of the disclosed timing method for web page browsing. First, the user's login information is received. The server starts a first timing system for timing according to the login information (step 210). The inline floating frame also starts a second timing system and updates regularly the first timing system on the server (step 220). The second timing system is set with a predetermined time. The system immediately compares the current time with the predetermined time (step 230). If the current time has reached the predetermined time, the server is called to update the first timing system (step 240), thereby timing the web page browsing time of the user.

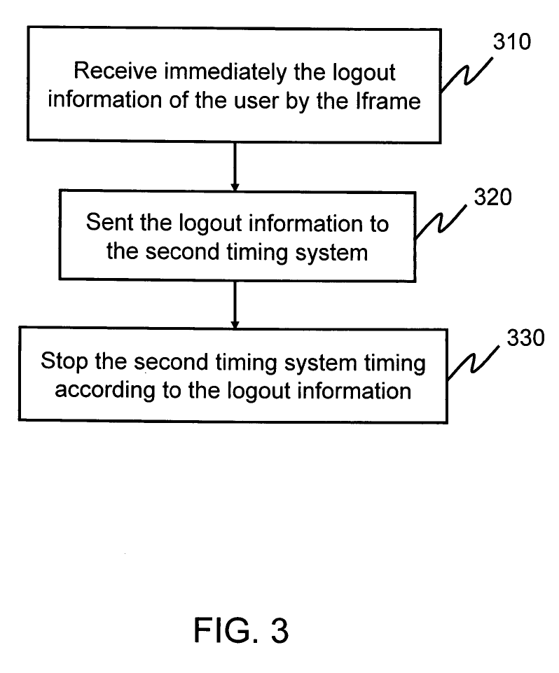

When the user anomalously quits or logs out the web page browsing, the system according to the invention automatically stops timing on the server according to the logout information. FIG. 3 shows the flowchart of the timing procedure when the user quits the web page browsing. First, the inline floating frame immediately receives the logout information of the user (step 310). The logout information is sent to the second timing system (step 320). The second timing system stops timing according to the logout information (step 330). Since the second timing system stops timing, it does not call the first timing system on server to time. After a period of time without receiving update information, the first timing system on server stops timing and keeps the current timing information.

When the user logs in again, the system verifies the user's identity. The timing systems are started again once the user passes the verification, timing the web page browsing time.

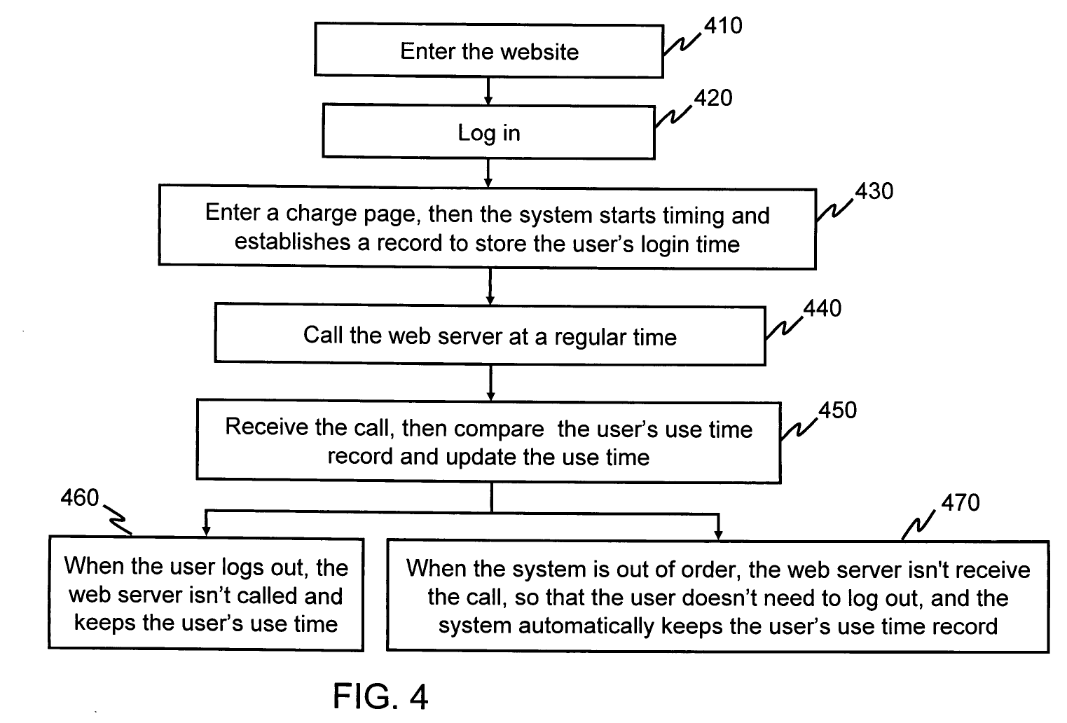

In the following, we use a charged English learning website as an example to explain the disclosed method in detail. As shown in FIG. 4, the user first enters the website (step 410) and logs in (step 420). the site for the English learning is charged by time; the user has to log onto the site. After the user logs in successfully, the web page enters a charge page, and the system starts timing and establishes a record to store the user's login time (step 430). The web page automatically starts timing and calls the web server at a regular time (step 440). Under normal uses, the web server compares the user's use time record according to the request and updates the use time (step 450). After the user logs out, the web page does not call the web server and the web server keeps the user's use time (step 460). If the system is out of order, the web server cannot receive the update request. The user does not need to log out, and the system automatically keeps the user's use time record (step 470).

The operation procedure of this embodiment is as follows:

Parent page
<html>
<body>
......
......
<iframe name=“counttime” SRC=“counttime.asp”
style=“visibility:hidden;”>
</iframe>
</body>
</html>
Timing page
<%
‘database operation
‘timing
‘determination of user's privilege
%>
<script language=“javascript”>
function login( ){
......
}
function logout{
......
}
function counttime( ){
......
window.setTimeout(window.open(‘...’,’_self’), 3000);
}
</script>
<html>
<body onload=”counttime( )”>
......
</body>
</html>

While the present invention has been particularly shown and described with reference to preferred embodiments thereof, it will be understood by those of ordinary skills in the art, that the various changes in form and details may be made therein without departing from the spirit and scope of the present invention as defined by the appended claims.

What is claimed is:

1. A web page browsing timing method for a web page that contains an inline floating frame (Iframe) to update a first timing system on a server according to a predetermined time, comprising the steps of:
receiving user's login information and starting the first timing system on timing;
updating regularly the first timing system by the inline floating frame, including the steps of:
starting a second timing system which is on the inline floating frame; and
comparing a current time with a time on the second timing system to acquire a comparison result; and
calling the server to update the first timing system thereof according to the comparison result.

2. The timing method of claim 1, further comprising the steps of:
receiving immediately logout information of the user by the inline floating frame after one of the step of receiving user's login information and starting the first timing system on timing, the step of updating regularly the first timing system by the inline floating frame, and the step of calling the server to update the first timing system thereof according to the comparison result;
sending the logout information to the second timing system; and
stopping the second timing system timing according to the logout information.

3. The timing method of claim 2, wherein the logout information includes information of anomalous logout.

4. The timing method of claim 1, wherein the step of receiving user's login information and starting the first timing system on timing comprises the step of identifying the user's identity by the server when the user logs in and resuming the timing for the same user according to the user's identity.

5. A web page browsing timing system for using a first timing system on a server to time while a user browses a web page, wherein the web page contains an inline floating frame which includes a second timing system to call the server for updating the first timing system according to a predetermined time.

6. The timing system of claim 5, wherein the inline floating frame immediately receives logout information of the user and sends the logout information to the second timing system for stopping timing.

7. The timing system of claim 6, wherein the logout information includes information of anomalous logout.

8. The timing system of claim 5, wherein the first timing system on the server resumes the timing for the same user according to the user's identity.
